(19) United States
(12) Patent Application Publication
(10) Pub. No.: US 2017/0081472 A1
(43) Pub. Date: Mar. 23, 2017

(54) PRODUCTION OF POLYAMIDES BY HYDROLYTIC POLYMERIZATION AND SUBSEQUENT TREATMENT IN A KNEADER

(71) Applicant: BASF SE, Ludwigshafen (DE)

(72) Inventors: Ning ZHU, Mannheim (DE); Ruediger HAEFFNER, Neustadt (DE); Achim STAMMER, Freinsheim (DE); Cesar ORTIZ, Neustadt (DE); Silke BIEDASEK, Ludwigshafen (DE); Faissal-Ali EL-TOUFAILI, Ludwigshafen (DE)

(73) Assignee: BASF SE, Ludwigshafen (DE)

(21) Appl. No.: 15/311,414

(22) PCT Filed: May 13, 2015
(86) PCT No.: PCT/EP2015/060607

§ 371 Date: Nov. 15, 2016

(30) Foreign Application Priority Data
May 16, 2014 (EP) 14168650.1

(51) Int. Cl. C08G 69/16; C08G 69/46; C08G 69/14

(52) U.S. Cl. CPC C08G 69/16; C08G 69/14; C08G 69/46

(57) ABSTRACT

The present invention provides a process for producing polyamides, which comprises
a) providing a monomer composition comprising at least one lactam or at least one aminocarbonitrile and/or oligomers of these monomers,
b) reacting the monomer composition provided in step a) in a hydrolytic polymerization at elevated temperature in the presence of water to obtain a reaction product comprising polyamide, water, unconverted monomers and oligomers,
c) the reaction product obtained in step b) being fed into at least one kneader (3) and subjected to a postpolymerization,
d) optionally forming the reaction product obtained in step c) to obtain polyamide particles,
e) optionally treating the reaction product obtained in step c) or the polyamide particles obtained in step d) with at least one extractant.

### BACKGROUND OF THE INVENTION

The present invention relates to a process for producing polyamides which comprises a hydrolytic polymerization and a subsequent treatment in a kneader.

### RELATED ART

Polyamides are among the polymers manufactured worldwide in a high production volume and are mainly used in fibers, engineering materials and film/sheet but also for a multiplicity of other purposes. Nylon-6 is the most commonly produced polyamide, its share being about 57%. Hydrolytic polymerization of ε-caprolactam is the classic way to produce nylon-6 (polycaprolactam) and is industrially still very significant. Conventional hydrolytic methods of production are described for example in Ullmann's Encyclopedia of Industrial Chemistry, Online edition 15.03.2003, Vol. 28, pp. 552-553 and Kunststoffhandbuch, % Technische Thermoplaste: Polyamide, Carl Hanser Verlag, 1998, Munich, pp. 42-47 and 65-70.

In the first process step of a hydrolytic polymerization, some of the lactam used reacts with water by ring-opening to form the corresponding ω-aminocarboxylic acid. This then reacts with further lactam in polycondensation reactions to form the corresponding polyamide. In one preferred version, 8-caprolactam reacts with water by ring-opening to form aminocaproic acid and then further to form nylon-6. The hydrolytic-polymerization process may be carried out in one stage or in more than one stage. In general, the polycondensation takes place in a vertical tubular reactor (known as a VK tube). The abbreviation “VK” (“vereinfacht kontinuierlich”) denotes a simplified continuous process. Optionally, it is possible to use a plant with a prepolymerization stage at elevated pressure, also known as a pressure prereactor. The use of such a prereactor reduces the residence time required for the ring-opening reaction of the c-caprolactam. At the downstream end of the upright tubular reactor (VK tube), a polyamide melt is obtained with a composition close to the chemical equilibrium between polyamide, lactam monomer, oligomers and water. The level of oligomers and monomers may be, for example, 8 to 15 wt %, while the viscosity number of the crude polyamide is directly related to the molar mass and thus the processing properties and is generally between 110 to 160 ml/g.

There are many end uses, for example the production of film/sheet for packaging materials, where the polyamide is required to have a low residual monomer content, and so before the crude polyamide is further processed it is generally subjected to an at least partial removal of monomers and oligomers.

To reduce the level of low molecular weight components, the product of hydrolytic polymerization is generally first converted into pellets of crude polyamide, which are subsequently extracted with an extractant to remove remaining monomers and oligomers. This frequently takes the form of continuous or batchwise extraction with hot water as described in DE 25 01 348 A and DE 27 32 328 A for example. To purify crude nylon-6, it is also known to extract with caprolactam-containing water (WO 99/26996 A2) or to treat in superheated steam (EP 0 284 986 A1). The extracted constituents, particularly caprolactam monomer and its cyclic oligomers in the case of nylon-6, are recycled into the process for environmental and economic reasons. Extraction is typically followed by a step of drying the extracted polyamide.

There are many applications where the polyamides are required to have comparatively high molecular weights that are not achieved by hydrolytic polymerization alone. To enhance its molecular weight and/or viscosity, the extracted and dried polyamide is subjected to a postcondensation, for which the polyamide is preferably in the solid state. A postcondensation may take the form of a heat treatment of polyamide material at temperatures below the melting point of the polyamide, during which it is the polycondensation reaction which is progressed in particular. This leads to an increase in the molecular weight of the polyamide and hence to an increase in its viscosity number. The viscosity number of nylon-6 following extraction and postpolymerization is generally in the range from 180 to 260 ml/g.

Postcondensation and drying are frequently carried out in one process step (WO 2009/153340 A1, DE 199 57 664 A1).

DD 2090899 describes processes for vacuum melt demonomerization performed after a polyamide extraction in which the polyamide melt is contacted with liquid caprolactam.

DD 227140 describes a process for producing polyamide having a degree of polymerization DP>200. There are 5 or more consecutive stages in the process. Every drying stage comprises first adjusting the surface area of the liquid polyamide melt to >4 cm²/g of polyamide and the maximum diffusion path length for the water in the melt to <3 mm.

WO 03/040212 discloses a method of producing nylon-6 by hydrolytic polymerization of ε-caprolactam in the presence of water. Dewatering is achieved by increasing the surface area of the melt.

An alternative route to polyamides, as yet not widely practiced on a large industrial scale, is via the polycondensation of aminonitriles, for example the production of nylon-6 from 6-aminocapronitrile (ACN). A typical procedure comprises a nitrile hydrolysis and subsequent aminoamidation, which are generally carried out in separate reaction steps in the presence of a heterogeneous catalyst, such as Ti02. A multistaged process has been found to be practicable, since the two reaction steps have different requirements with regard to water content and completeness of reaction.

With this route, it is again frequently advantageous to subject the polymer obtained to a purifying step to remove monomers/oligomers.

WO 00/47651 A1 describes a continuous process for producing polyamides by reacting at least one aminocarbonitrile with water.

Existing processes for producing polyamides by hydrolytic polymerization are still in need of improvement. For instance, the level of residual monomer, specifically ε-caprolactam monomer, at the start of postpolymerization below the melting point of the polyamide is still far below the equilibrium value. Therefore, a reverse polycondensation (remonomerization) reaction can take place during the concluding polymerization, such that the residual monomer content of the polyamide goes back up in the last process step of the production process.

The present invention therefore has for its object to provide an improved hydrolytic process for producing polyamides wherein the aforementioned disadvantages are avoided. More particularly, this process shall make it possible to provide a product of sufficiently high molecular weight and at the same time very low residual monomer content. It shall specifically be possible to eschew a postcondensation following extraction and drying at least to some extent or completely. This makes it possible to reduce or avoid any renewed increase in the residual monomer content after extraction.

It was found that this object is achieved when the reaction mixture obtained in the hydrolytic polymerization, said reaction mixture comprising polyamide, water, unconverted monomers and oligomers, is subjected to a postpolymerization in a kneader which has a head space zone. The product obtained therefrom may optionally be subjected to at least an extraction wherein unconverted monomers and oligomers are at least partly removed. This may be followed by still further workup steps, for example a drying step. In the process of the present invention, the discharge from the at least one kneader advantageously is essentially already at target molecular weight, i.e., the desired viscosity number. Therefore, polyamides of comparatively low residual monomer content are obtainable after just the at least one kneader. An extraction is only left to remove low fractions of low molecular weight components. Subsequent drying can be carried out under lower temperatures and/or a lower consumption of inert gas. There is generally no longer any need for a process step of postcondensation subsequent to extraction and drying. It may well be the case that the process steps of extraction and drying are also no longer necessary. The process of the present invention offers shorter residence and throughput times than conventional processes. A particular accomplishment is the provision of polyamides having a low residual content of both lactam monomer and cyclic dimer.

### SUMMARY OF THE INVENTION

The invention accordingly provides a process for producing polyamides, having the following process steps:
a) providing a monomer composition comprising at least one lactam or at least one aminocarbonitrile and/or oligomers of the same,
b) reacting the monomer composition provided in process step a) in a hydrolytic polymerization at elevated temperature in the presence of water to obtain a reaction product comprising polyamide, water, unconverted monomers and oligomers, and
c) postpolymerizing the reaction product obtained in process step b) in at least one kneader (3), wherein said kneader (3) as employed in process step c) includes at least two screws, wherein at least one reaction zone and a discharge zone is arranged in the direction of the longitudinal axes of the screws and in the at least one reaction zone there are kneading elements arranged consecutively on each of the screws, wherein inside said kneader (3) a head space zone is provided above the at least two screws with a head space volume in the range from 10 to 70%, based on the overall volume of the at least one reaction zone.

The invention further provides polyamides obtainable by the process described above. These polyamides are notable for a very low residual monomer content that is unattainable with processes known from the prior art.

The invention further provides for the use of the above polyamides for producing pellets, film/sheet, fibers or moldings.

### DETAILED DESCRIPTION OF THE INVENTION

Herein a monomer is a low molecular weight compound as used in polyamide production by hydrolytic polymerization to introduce a single repeat unit. This definition comprehends the lactams and aminocarbonitriles used. It also comprehends comonomers optionally used for producing the polyamides, such as o-aminocarboxylic acids, a-aminocarboxamides, o-aminocarboxylic acid salts, a-aminocarboxylic esters, diamines and dicarboxylic acids, dicarboxylic acid/diamine salts, dinitriles and mixtures thereof.

Herein an oligomer is a compound as formed in polyamide production as a result of a reaction between at least two of the compounds forming individual repeat units. And an oligomer has a lower molecular weight than the polyamide obtained according to the present invention. Oligomers include cyclic and linear oligomers, specifically cyclic dimer, linear dimer, timer, tetramer, pentamer, hexamer and heptamer. Commonly used methods to determine the oligomeric components of polyamides generally capture the components up to the heptamer.

The viscosity number (Staudinger function, referred to as VN or J) is defined as VN=1/c×(η−ηₛ)/ηₛ. The viscosity number is directly related to the average molar mass of the polyamide and provides information about the processability of a polymer. The viscosity number may be determined to EN ISO 307 using a Ubbelohde viscometer.

The process of the present invention has the following advantages:
Using a kneader having a head space zone for postpolymerization delivers the molecular weight increase to the final molecular weight at a much earlier stage in the manufacturing compared with conventional processes. The residence and throughput times of the manufacturing can be reduced as a result. The kneader is not followed by a process step wherein the polymer would be exposed to a comparatively severe thermal stress of the kind associated with a postpolymerization for example. The renewed formation of monomers and/or oligomers which occurs as an equilibrium reaction at comparatively high temperatures is thus avoided. Very low residual monomer contents are thus made possible.
   The head space zone, i.e., a space that is free from internals, can provide an improved devolatilization over a kneader without same.
A postcondensation, for example in a dryer, as with conventional processes is not required. As a result, a process stage can be saved and the residence and throughput times in the manufacturing are shorter.
Owing to the upstream kneader, the extraction has to remove less by way of monomer and/or oligomer, e.g., caprolactam; i.e., the extraction stage has to remove less by way of low molecular weight components.
Owing to the kneader being upstream of the extraction, less drying capacity is needed; i.e., the design rating for the drying performance of the process may be reduced or the output may be increased for the same drying performance.

Process Step a)

Process step a) of the process according to the present invention comprises reacting a monomer mixture comprising at least one lactam or at least one aminocarbonitrile and/or oligomers of these monomers and possibly further components under polyamide-forming reaction conditions to form a polyamide.

For the purposes of the present invention, polyamides are homopolyamides, copolyamides and also polymers comprising at least one lactam or nitrile and at least one further monomer in polymerized form and containing at least 60 wt % of polyamide foundational building blocks, based on the overall weight of the polyamide's monomeric foundational building blocks.

Homopolyamides are derived from one aminocarboxylic acid or from one lactam and can be described in terms of a single repeat unit. Nylon-6 foundational building blocks may be constructed from caprolactam, aminocapronitrile, aminocaproic acid or mixtures thereof, for example. Examples of homopolyamides are nylon-6 (PA 6, polycaprolactam), nylon-7 (PA 7, polyenantholactam or polyheptanamide), nylon-10 (PA 10, polydecanamide), nylon-11 (PA 11, polyundecanolactam) and nylon-12 (PA 12, polydodecanolactam).

Copolyamides are derived from two or more different monomers which are each linked together through an amide bond.

Possible copolyamide building blocks are derivable for example from lactams, aminocarboxylic acids, dicarboxylic acids and diamines. Preferred copolyamides are polyamides formed from caprolactam, hexamethylenediamine and adipic acid (PA 6/66). Copolyamides may comprise the polyamide building blocks in various ratios.

Polyamide copolymers in addition to the polyamide foundational building blocks comprise further foundational building blocks not connected together through amide bonds. The proportion of comonomers in polyamide copolymers is preferably at most 40 wt %, more preferably at most 20 wt %, especially at most 10 wt %, based on the overall weight of the foundational building blocks of the polyamide copolymer.

The polyamides obtained by the process of the present invention are preferably selected from nylon-6, nylon-11, nylon-12 and their copolyamides and polymer blends thereof. Nylon-6 and nylon-12 are particularly preferable, while nylon-6 is especially preferable.

The monomer mixture provided in process step a) preferably comprises at least one C₅ to C₁₂ lactam and/or an oligomer thereof. The lactams are particularly selected from ε-caprolactam, 2-piperidone (δ-valerolactam), 2-pyrrolidone (γ-butyrolactam), capryllactam, enantholactam, lauryllactam, their mixtures and oligomers thereof.

It is particularly preferred for process step a) to provide a monomer mixture comprising ε-caprolactam, 6-aminocapronitrile and/or an oligomer thereof. Process step a) specifically provides a monomer mixture comprising exclusively ε-caprolatam or exclusively 6-aminocapronitrile as monomer component.

It is further also possible for process step a) to provide a monomer mixture which in addition to at least one lactam or aminocarbonitrile and/or oligomer thereof comprises at least one monomer (M) copolymerizable therewith.

Suitable monomers (M) are dicarboxylic acids, for example aliphatic C₄₋₁₀ alpha, omega-dicarboxylic acids, such as succinic acid, glutaric acid, adipic acid, pimelic acid, suberic acid, acelaic acid, sebacic acid and dodecanedioic acid. Aromatic C₈₋₂₀ dicarboxylic acids, such as terephthalic acid and isophthalic acid, can also be used.

Diamines useful as monomers (M) include α,ω-diamines having four to ten carbon atoms, such as tetramethylenediamine, pentamethylenediamine, hexamethylene-diamine, heptamethylenediamine, octamethylenediamine, nonamethylenediamine and decamethylenediamine. Hexamethylenediamine is particularly preferable.

Among those salts of said dicarboxylic acids and diamines that are useful as monomers (M) it is especially the salt of adipic acid and hexamethylenediamine—known as 66 salt—which is preferable.

Useful monomers (M) further include lactones. Examples of preferred lactones are ε-caprolactone and/or γ-butyrolactone.

Polyamides are obtainable using one or more chain transfer agents, for example aliphatic amines or diamines such as triacetonediamine or mono- or dicarboxylic acids such as propionic acid and acetic acid or aromatic carboxylic acids such as benzoic acid or terephthalic acid.

Process Step b)

The monomer mixture provided in process step a) may be reacted in a hydrolytic polymerization in process step b) according to customary methods known to a person skilled in the art. Such a method is described for example in Kunststoff Handbuch, ¾ Technische Thermoplaste: Polyamide, Carl Hanser Verlag, 1998, Munich, pp. 42-47 and 65-70. This disclosure is hereby fully incorporated herein by reference.

The hydrolytic polymerization of process step b) preferably takes the form of a lactam being subjected to ring opening in the presence of water. The effect is, for example, to cleave the lactam at least partly into the corresponding aminocarboxylic acid, which then polymerizes further in a subsequent step by polycondensation. When, in a preferred embodiment, a caprolactam-comprising monomer mixture is provided in process step a), the caprolactam is at least partly opened in the presence of water to form the corresponding aminocaproic acid and subsequently reacts by poly-condensation to form the nylon-6. In an alternative embodiment, an aminocarbonitrile, specifically 6-aminocapronitrile, is subjected in process step b) to a polymerization in the presence of water and optionally in the presence of a catalyst.

The reaction in process step b) is preferably carried out in a continuous manner.

The hydrolytic polymerization in process step b) is preferably carried out in the presence of 0.1 to 25 wt % of added water, more preferably in the presence of 0.5 to 20 wt % of added water, based on the overall amount of monomers and oligomers used. Additional water formed in the course of the condensation reaction is not included in this statement of amount.

The hydrolytic polymerization in process step b) can be carried out in one or more stages (in two stages, for example). When the hydrolytic polymerization in process step b) is carried out as a single stage, the initial concentration of water is preferably in the range from 0.1 to 4 wt %, based on the overall amount of monomers and oligomers used. When the hydrolytic polymerization in process step b) is carried out in two stages, then the VK tube is preferably connected downstream of a preliminary pressure stage, for example a pressure prereactor. In the preliminary pressure stage, the initial concentration of water is preferably in the range from 2 to 25 wt % and more preferably in the range from 3 to 20 wt %, based on the overall amount of monomers and oligomers used.

In one specific embodiment, the monomer mixture provided in process step a) consists of at least one lactam and the hydrolytic polymerization in process step b) is carried out in the presence of 0.1 to 4 wt % of water, based on the overall amount of lactam used. The lactam concerned is specifically ε-caprolactam.

The hydrolytic polymerization in process step b) may be carried out in the presence of at least one chain transfer agent, such as propionic acid. When a chain transfer agent is used in process step b) and the hydrolytic polymerization is carried out in two stages by using a preliminary pressure stage, the chain transfer agent may be used in the preliminary pressure stage and/or in the second polymerization stage. In one specific mode, the hydrolytic polymerization in process step b) is not carried out in the presence of a chain transfer agent.

The polyamides obtained in the process of the present invention may further comprise customary additives such as delusterants, e.g., titanium dioxide, nucleators, e.g., magnesium silicate, stabilizers, e.g., copper(I) halides and alkali metal halides, antioxidants, reinforcing agents, etc, in customary amounts. Additives are generally added before, during or after the hydrolytic polymerization (process step b). The additives are preferably added before the hydrolytic polymerization in process step b).

The reaction in process step b) may be carried out in one or more stages (in two stages, for example). In a first embodiment, the reaction in process step b) is carried out as a single stage. Preferably, the lactam or aminocarbonitrile and any oligomers thereof are made to react with water and optionally additives in a reactor.

The customary reactors for producing polyamides and known to a person skilled in the art are suitable. Preferably, the hydrolytic polymerization in process step b) is carried out in one polymerization tube or in a bundle of polymerization tubes. The hydrolytic polymerization in process step b) is specifically carried out using at least a so-called VK tube. The abbreviation “VK” (“vereinfacht kontinuierlich”) denotes a simplified continuous process. When the reaction in process step b) is carried out in a multi-stage form, it is preferable for at least one of the stages to take place in a VK tube. In a two-stage form for the reaction in process step b) it is preferably the second stage which takes place in a VK tube. In a two-stage form for the reaction in process step b), the first stage may be carried out in a pressure prereactor. When an aminocarbonitrile is used, the reaction in process step b) is generally carried out in a multi-stage form wherein the first stage preferably takes place in a pressure prereactor.

In one suitable embodiment, nylon-6 is produced in a multi-stage process, specifically a two-stage process. Caprolactam, water and optionally at least one additive, for example a chain transfer agent, are fed into the first stage and converted into a polymer composition. This polymer composition may be transferred into the second stage under pressure or by a melt discharge pump. This is preferably effected via a melt distributor.

The hydrolytic polymerization in process step b) is preferably carried out at a temperature in the range from 240 to 280° C. When the hydrolytic polymerization in process step b) is carried out in a multi-stage form, the individual stages may be carried out at the same temperature or at different temperatures and pressures. When a polymerization stage is carried out in a tubular reactor, specifically a VK tube, the reactor may have substantially the same temperature along its entire length. Another possibility is a temperature gradient in one part of the tubular reactor at least. Another possibility is to conduct the hydrolytic polymerization in a tubular reactor having two or more than two reaction zones, which are operated at differing temperature and/or differing pressure. A person skilled in the art is able to choose the best conditions as required, for example by having regard to the equilibrium conditions.

When the hydrolytic polymerization in process step b) is carried out as a single stage, the absolute pressure in the polymerization reactor is preferably in the range of about 1 to 10 bar, more preferably in the range from 1.01 bar up to 2 bar. It is particularly preferable for the single-stage polymerization to be carried out at ambient pressure.

In one preferred embodiment, the hydrolytic polymerization in process step b) is carried out in two stages. Performing a so-called pressure stage first will speed up the process, since the rate-determining step of cleaving the lactam, specifically the caprolactam, is carried out under elevated pressure under otherwise similar conditions to those in the second reaction stage. The second stage is then preferably carried out in a VK tube as described above. The absolute pressure in the first stage is preferably in the range of about 1.5 to 70 bar, more preferably in the range from 2 to 30 bar. The absolute pressure in the second stage is preferably in the range of about 0.1 to 10 bar, more preferably in the range from 0.2 bar up to 5 bar. The second stage is more particularly carried out at ambient pressure.

Process Step c)

Process step c) of the process according to the present invention comprises the reaction product obtained in process step b) being supplied to at least one kneader having a head space zone and subjected to a postpolymerization.

The kneader as used in process step c) heats up at least two screws, wherein at least one reaction zone and a discharge zone is arranged in the direction of the longitudinal axes of the screws and in the at least one reaction zone there are kneading elements arranged consecutively on each of the screws, wherein inside the kneader above the at least two screws there is provided a head space zone which has a head space volume in the range from 10 to 70%, based on the overall volume of the at least one reaction zone.

It is essential to the present invention that the postpolymerization is carried out in a modified kneader as compared with conventional kneaders:

The starting point is a conventional kneader having at least two essentially horizontal screws supporting consecutively arranged kneading elements scraping along the inner wall of an elongate horizontal housing.

The invention is not restricted regarding the specific embodiments of screws and kneading elements. Kneaders having eccentric kneading elements are preferable. Self-cleaning kneaders as described for example in EP 2732870 are particularly preferable.

Proceeding from the above conventional kneaders, the invention provides essentially that the kneader employed for postpolymerization is a modified kneader such that it has a head space zone above the kneading internals (screws and kneading elements), i.e., that the housing is free from kneading internals in its upper region.

This region is required by the invention to have a head space volume in the range from 10 to 70%, based on the overall volume of the at least one reaction zone forming the housing interior or part of said interior.

Preference is further given to a head space volume of from 15 to 60%, in particular from 20 to 40%, all based on the overall volume of the at least one reaction zone.

The temperature in the postpolymerization reaction zone is preferably in the range from 200 to 350° C., more preferably from 220 to 300° C.

The absolute pressure in the postpolymerization reaction zone is typically in the range from 1 mbar to 1.5 bar, more preferably from 500 mbar to 1.3 bar.

The temperature in the reaction zone is set by indirect heat transfer using the heat exchangers customary for this. This heat exchanger may have a customary heat transfer medium flowing through it. Examples of customary heat transfer media are oils, water and steam. The temperature in the reaction zone may also be set by electric heating or other suitable devices.

In one preferred embodiment, the postpolymerization in process step c) is carried out in the presence of at least one inert gas, preferably nitrogen. This inert gas is fed directly to the polyamide in the kneader.

The inert gas can be preheated, preferably to from 200 to 350° C., more preferably from 220 to 300° C., on entry into the kneader.

The preferred volume ratio between inert gas and polymer melt is in the range from 10:1 to 100:1, provided the volume of the inert gas is specified in standard cubic meters.

For the purposes of the present invention, one standard cubic meter is that amount of gas which would have a volume of one cubic meter at a pressure of 1.013 bar, a relative humidity of 0% (dry gas) and a temperature of 288.15 K=15° C. (standard atmosphere to ISO 2533).

The residence time of the reaction mixture in the kneader(s) used in process step c) is preferably in the range from 5 to 300 minutes, more preferably in the range from 10 to 240 minutes and most preferably in the range from 20 to 170 minutes.

In one preferred embodiment of the kneader, the separation between the longitudinal axes of the at least two screws is in the range from 10 to 3000 mm, preferably in the range from 50 to 2000 mm, more preferably in the range from 100 to 1000 mm and most preferably in the range from 200 to 800 mm.

In one preferred embodiment, the at least two screws are corotating or contrarotating. When there are more than two screws, it is possible for all the screws to be corotating or for a desired number of screws to be contrarotating.

In the context of the present invention, corotating is to be understood as meaning that the at least two screws rotate in the same direction. Contrarotating in the context of the present invention is to be understood as meaning that the at least two screws rotate in the opposite direction. Contrarotating operation of the screws versus a corotating mode produces more intensive shearing and extension of the reaction product and more homogeneous commixing.

The at least two screws are preferably contrarotating.

In one preferred embodiment of the kneader, the kneading elements arranged in series on the screws in the direction of the longitudinal axes have radial offset angles between the kneading elements in the range from 0° to 360° , preferably in the range from 20° to 300° , more preferably in the range from 40° to 240° and even more preferably in the range from 60° to 120°.

In one preferred embodiment of the kneader, the kneading elements arranged in series on each of the screws in the direction of their longitudinal axis are arranged excentrically.

In one preferred embodiment, the kneader used in process step c) has kneading elements in the region of the reaction zone which have a length to diameter ratio in the range from 1 to 20, preferably in the range from 3 to 10 and more preferably in the range from 4 to 6.

In the present document, kneading element length refers to the length of a kneading element in the axial direction and diameter refers to the maximum outside diameter of a circular area swept in one rotating movement of a kneading element.

Preferably, the kneading elements are selected from kneading disks, kneading blocks, kneading screws and combinations thereof.

Preferably, the kneading elements have an inside region where they are solid, hollow, have cutouts, have struts, as combinations thereof.

Preference is given to kneading elements of solid and fully filled inside region and/or hollow and partially filled inside region.

Advantageously, the kneader includes at least one devolatilization device.

Herein devolatilization device refers to a device for removing gases and other volatile substances, for example solvents, moisture, water vapor, caprolactam monomer from liquids, solid bodies and/or other media, in particular from the media transported in the kneader. Devolatilization may be effected for example by mechanical surface area enlargement and/or commixing of the medium transported in the kneader. To devolatilize the medium transported in the kneader, a negative pressure may further also be applied to said medium. Examples of devolatilization devices are continuous devolatilizers, driven shafts with combs and/or spatulas, vacuum pumps, deaeration valves, combinations thereof.

Preferably, the gaseous discharge from the kneader is subjected to a separation of the volatile components comprised therein, which are preferably selected from water, monomer, oligomers and mixtures thereof.

Preferably, the discharge from the kneader in process step c) has a viscosity number in the range from 120 to 300 ml/g, preferably in the range from 130 to 280 ml/g and more preferably in the range from 150 to 250 ml/g.

Preferably, the viscosity number of the reaction product discharged in process step c) evinces an increase over the reaction product imported in process step c), said increase being in the range from 0 to 200%, preferably in the range from 10 to 150% and most preferably in the range from 30 to 120%.

Preferably, the discharge from the kneader in process step c) has a residual monomer content in the range from 0 to 5%, preferably in the range from 0.1 to 3% and most preferably in the range from 0.2 to 1.5%.

Preferably, the discharge from the kneader in process step c) has a cyclic dimer content in the range from 0 to 5%, preferably in the range from 0.1 to 3% and most preferably in the range from 0.2 to 0.5%.

Process Step d)

Process step d) of the process according to the present invention comprises optionally forming the reaction product obtained in process step c) to obtain polyamide particles.

Preferably, the reaction product obtained in process step c) is first formed into one or more strands. Devices known to a person skilled in the art may be used for this. Suitable devices include, for example, breaker plates, dies or die plates. Preferably, the reaction product obtained in process step c) is in the flowable state when it is formed into strands and is in the form of a flowable strand-shaped reaction product when it is subjected to a comminution into polyamide particles. The hole diameter is preferably in the range from 0.5 mm to 20 mm, more preferably from 0.75 mm to 5 mm and most preferably from 1 to 3 mm.

The forming in process step d) preferably comprises a pelletization. For pelletization, the reaction product which is obtained in process step c) and formed into one or more strands may be solidified and then pelletized. Suitable measures are described, for example, in Kunststoffhandbuch, Technische Thermoplaste: Polyamide, Carl Hanser Verlag, 1998, Munich, pp. 68-69. Underwater pelletization, which is likewise known in principle to a person skilled in the art, is a specific method of forming.

Process Step e)

Process step e) comprises the polyamide particles obtained in process step d) being subjected to a first extraction.

Suitable processes and apparatus for extraction of polyamide particles are known in principle to a person skilled in the art.

Extraction is to be understood as meaning that the level of monomers and any dimers and further oligomers in the polyamide is reduced by treatment with an extractant. Industrially, this can be accomplished, for example, by continuous or batchwise extraction with hot water (DE 25 01 348 A, DE 27 32 328 A) or in superheated steam (EP 0 284 968 W1).

Extraction in process step e) preferably utilizes a first extractant, which comprises water or consists of water. In one preferred embodiment, the first extractant consists of water only. In a further preferred embodiment, the first extractant comprises water and a lactam used for producing the polyamide and/or oligomers of said lactam. Nylon-6 may thus also be extracted with caprolactam-containing water as described in WO 99/26996 A2.

Extractant temperature is preferably in the range from 75 to 130° C., more preferably in the range from 85 to 120° C.

Extraction may be carried out as a continuous operation or as a batch operation. A continuous extraction is preferable.

The extraction may be carried out with the polyamide particles and the first extractant moving cocurrently or countercurrently. Countercurrent extraction is preferable.

In a first preferred embodiment, the polyamide particles are extracted with water in continuous countercurrent at a temperature 100° C. and ambient pressure. The temperature is then preferably in the range from 85 to 99.9° C.

In a further preferred embodiment the polyamide particles are extracted with water in continuous countercurrent at a temperature 100° C. and a pressure in the range from 1 to 2 bar absolute. The temperature is then preferably in the range from 101 to 120° C.

Customary apparatus known to a person skilled in the art can be used for the extraction. In one specific mode, at least a pulsed extraction column is used.

The components in the laden first extractant obtained in process step e), which are selected from monomers and any dimers and/or oligomers, may also be isolated and recycled into process step a) or b).

The extracted polyamide obtained in process step e) may be subjected to drying (process step f)). The principle of drying polyamides is known to a person skilled in the art. For example, the extracted pellets may be dried by contacting them with dry air or a dry inert gas or a mixture thereof. It is preferred to use an inert gas, e.g., nitrogen, for drying. The extracted pellets may also be dried by contacting them with superheated steam or a mixture thereof with some other gas, preferably an inert gas. Customary dryers may be used, examples being countercurrent, crossflow, pan, tumble, paddle, trickle, cone and tower dryers, fluidized beds, etc. One suitable mode comprises batchwise drying in a tumble dryer or cone dryer under reduced pressure. A further suitable mode comprises continuous drying in so-called drying tubes which have an inert gas under the drying conditions flowing through them. In one specific mode, at least a tower dryer is used. The tower dryer preferably has a hot inert gas under the postpolymerization conditions flow through it. Nitrogen is a preferred inert gas.

Preferably, the process is a continuous process or a batch process.

Preferably, drying in process step f) is conducted at a temperature in the range from 70 to 220° C., preferably in the range from 100 to 200° C. and most preferably in the range from 140 to 180° C.

Preferably, the polyamide obtained according to the process of the present invention has a number-average molecular weight Mₙ in the range from 10 000 to 40 000 g/mol, preferably in the range from 12 000 to 30 000 g/mol and most preferably in the range from 13 000 to 25 000 g/mol.

The process of the present invention leads to polyamides having particularly advantageous properties, in particular to high viscosity coupled with a very low residual monomer content.

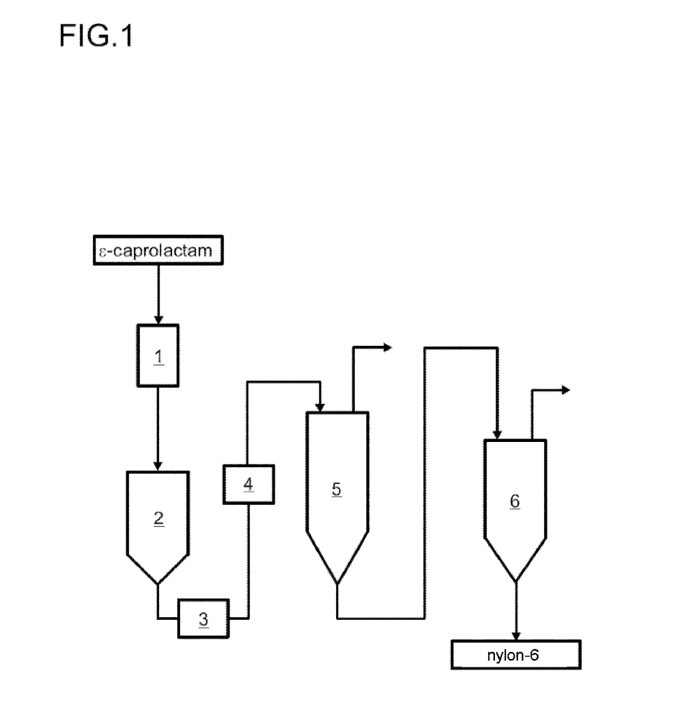

The process will now be more particularly elucidated by FIG. 1 and the examples.

FIG. 1 shows a schematic of one mode to carry out the process of the present invention.

The following reference signs are used in FIG. 1:

| | |
|---|---|
| 1 | pressure prereactor |
| 2 | VK tube |
| 3 | kneader |
| 4 | pelletizer |
| 5 | extraction |
| 6 | drying |

A monomer composition provided in process step a) is fed, optionally via a pressure reactor 1, to a VK tube 2. Process step b) takes place in optionally said pressure reactor 1 and/or said VK tube 2. The reaction product obtained in process step b) is supplied in process step c) to a kneader 3 and subjected to a postpolymerization. Optionally, the reaction product obtained in process step c) is subjected to forming in a pelletizer 4 to obtain polyamide particles. Optionally, the reaction product obtained in process step c) or the polyamide particles obtained in process step d) are treated with at least one extractant in an extraction 5. Optionally, the extracted polyamide obtained in process step e) is additionally subjected to a drying step 6.

### WORKING EXAMPLES

### Working Example 1

A nylon-6 pellet material produced on an industrial scale with a viscosity number of 143 ml/g and a caprolactam content of 9.96% was melted and the melt was fed under nitrogen (80 l(s.t.p.)/h) to a KRC type kneader from Kurimoto having a head space volume of 21% for postpolymerization. The residence time in the kneader was 16 min at a temperature of 290° C. The kneader output was pelletized by underwater pelletization and subsequently dried. The end product had a viscosity number of 156 ml/g and a caprolactam content of 3.986%.

### Working Example 2

Working example 2 was carried out similarly to working example 1 except that, unlike working example 1, the residence time in the kneader was 60 min.

The end product had a viscosity number of 225 ml/g and a caprolactam content of 0.39%.

### Working Example 3

Working example 3 was carried out similarly to working example 1 except that, unlike working example 1, the residence time in the kneader was 100 min.

The end product had a viscosity number of 254 ml/g and a caprolactam content of 0.264%.

1. A process for producing a polyamide, the process comprising:
a) reacting a monomer composition by hydrolytic polymerization at elevated temperature in the presence of water to obtain a reaction product comprising a polyamide, water, unconverted monomers and oligomers; and
b) postpolymerizing the reaction product a) in at least one kneader, to obtain a reaction product b),
wherein:
the monomer composition comprises at least one lactam, at least one aminocarbonitrile, an oligomer of at least one lactam, an oligomer of at least one aminocarbonitrile, an oligomer of at least one lactam and at least one aminocarbonitrile, or a mixture thereof;
the kneader includes at least two screws;
at least one reaction zone and a discharge zone are arranged in a direction of a longitudinal axes of the at least two screws;
in the at least one reaction zone there are kneading elements arranged consecutively on each of the at least two screws; and,
inside the kneader a head space zone is provided above the at least two screws with a head space volume ranging from 10 to 70%, based on an overall volume of the at least one reaction zone.

2. The process according to claim 1, further comprising:
c) forming the reaction product b) to obtain polyamide particles.

3. The process according to claim 1, further comprising:
d) treating the reaction product b) with an extractant, to obtain an extracted polvamide.

4. The process according to claim 3, further comprising:
e) drying the extracted polyamide.

5. The process according to claim 1, wherein the monomer composition comprises ε-caprolactam,. 6-aminocapronitrile, an oligomer of ε-caprolactam, an oligomer of 6-aminocapronitrile, an oligomer of ε-caprolactam and 6-aminocapronitile, or a mixture thereof.

6. The process according to claim 1, wherein the head space zone has a head space volume ranging from 15 to 60%, based on the overall volume of the at least one reaction zone.

7. The process according to claim 1, wherein the kneader has an inert gas flowing through it.

8. The process according to claim 4, wherein the drying is conducted at a temperature ranging from 70 to 220° C.

9. A polyamide obtainable by the process of claim 1.

10. A method, comprising forming an article with the polyamide of claim 9, wherein the article is selected from the group consisting of a pellet, a film, a sheet, a fiber and a molding.

11. The process according to claim 2, further comprising:
d) treating the polyamide particles with an extractant.
